(19) United States
(12) Patent Application Publication
(10) Pub. No.: US 2014/0042080 A1
(43) Pub. Date: Feb. 13, 2014

(54) REVERSE OSMOSIS MEMBRANE ELEMENT

(71) Applicant: A. O. SMITH (SHANGHAI) WATER TREATMENT PRODUCTS CO. LTD., Shanghai (CN)

(72) Inventors: Yizhi Hou, Shanghai (CN); Qiang Wang, Shanghai (CN)

(21) Appl. No.: 13/962,750

(22) Filed: Aug. 8, 2013

(30) Foreign Application Priority Data
Aug. 10, 2012 (CN) 201210285137.7

(51) Int. Cl. B01D 63/10

(52) U.S. Cl. CPC B01D 63/10
USPC 210/494.3

(57) ABSTRACT

A reverse osmosis membrane element has a relatively high recovery rate. In the present invention, water ports of the reverse osmosis membrane element are located at both ends thereof, and a waterproof adhesive tape is coated between a flow guide net and a reverse osmosis membrane of the reverse osmosis membrane element, including a plurality of adhesive tapes parallel with an axial direction of the reverse osmosis membrane element, so that fed water is discharged from the water outlet after circuitously flowing between adjacent adhesive tapes along the axial direction of the reverse osmosis membrane element. In the technical solution of the present invention, a circuitous flow passage is available in the reverse osmosis membrane element, which increases the fluid flow rate, and decreases the surface pollution rate of the reverse osmosis membrane, thereby contributing to the improvement of the recovery rate of the reverse osmosis membrane element.

### CROSS-REFERENCE TO RELATED APPLICATION

This application claims priority to Chinese Utility Patent Application No. 20120285137.7, filed Aug. 10, 2013, the contents of which are incorporated herein by reference.

### BACKGROUND

The present invention relates to reverse osmosis water treatment technology and, more specifically, to a reverse osmosis membrane element.

A spiral wound reverse osmosis membrane element (also referred to as a wound reverse osmosis membrane element) is a conventional element used in water treatment technology. Referring to FIG. 1, a spiral wound reverse osmosis membrane element 10 includes a cylindrical housing 12 acting as a pressure vessel, through which a central tube 14 extends. Referring to FIG. 2, which illustrates the reverse osmosis membrane element 10 in an unrolled state, the central tube 14 defines a plurality of holes 16. Multiple alternating layers of reverse osmosis membrane 18 and flow guide net 20 are laminated and wound around the central tube 14. The central tube 14 is connected to the housing 12 through end connectors 21, one of which is illustrated in FIG. 2.

With reference to FIG. 1, in usage, raw water 22 enters the housing 12 through one end thereof. A portion of the raw water 22 forms water of lower concentration by passing through the reverse osmosis membrane 18 (FIG. 2) under the pressure, then entering the central tube 14 through the holes 16 and flowing out of one or both ends of the central tube 12. Such water can be called product water or fresh water 24 (FIG. 1). The other part of the raw water flows out of the other end of the housing 12, and can be called as waste water or concentrated water 26.

Referring to FIG. 3, with the reverse osmosis membrane 18 and the flow guide net 20 of the reverse osmosis membrane element expanded (i.e., unrolled), a flow direction of the recovered concentrated water is illustrated schematically. In FIG. 3, the central tube 14 defines a water inlet end at an upper side 27, a water outlet end at a lower side 28, and the flow direction of the concentrated water is indicated by an arrow 29 from the upper side 27 to the lower side 28.

For the reverse osmosis membrane element in the prior art, as illustrated in FIGS. 1-3, a large part of the raw water is discharged as the concentrated water after being processed, and only a small part of the raw water becomes the fresh water. Thus, the fresh water accounts for a small portion of the amount of the raw water, i.e., the recovery rate is low.

### SUMMARY

In view of this, the present invention provides a reverse osmosis membrane element which has a relatively high recovery rate. In order to achieve the above object, the present invention provides the following technical solution.

A reverse osmosis membrane element with water ports at both ends thereof, wherein a waterproof adhesive tape is coated between a flow guide net and a reverse osmosis membrane of the reverse osmosis membrane element, including a plurality of adhesive tapes parallel with an axial direction of the reverse osmosis membrane element, so that the fed water is discharged from the water outlet after circuitously flowing between adjacent adhesive tapes along the axial direction of the reverse osmosis membrane element.

Optionally, positions of the waterproof adhesive tapes comprise: in a state where the flow guide net and the reverse osmosis membrane are expanded, edges of a group of opposite sides parallel with winding direction, wherein a portion of a first side of the group of opposite sides, which portion is close to a winding start end, is reserved for the water port, and a portion of a second side, which portion is close to a winding finish end, is reserved for the water port; edges of one side of a winding finish end, and, positions of a plurality of parallel lines extending alternatively from the first side and the second side to the opposite side without contacting the opposite side.

Optionally, in the state where the flow guide net is expanded, a width of the reserved water port is 10% to 25% of a length of the flow guide net in the winding direction.

Optionally, a distance between two adjacent ones of the plurality of parallel lines is 10% to 25% of the length of the flow guide net in the winding direction.

Optionally, the distance between two adjacent ones of the plurality of parallel lines is gradually narrowed along the winding direction; the reserved water port which is close to the winding start end is a water inlet, and the water port which is close to the winding finish end is a water outlet.

Optionally, the reserved water port which is close to the winding start end is a water inlet, and the water port which is close to the winding finish end is a water outlet; a segment of waterproof adhesive tape substantially parallel with a flow direction of the water and shorter than the parallel lines is provided at a position at a corner of a water flow and in front of a location where the water flow turns around.

According to the technical solution of the present invention, a circuitous flow passage is available in the reverse osmosis membrane element, which increases the flow rate of the fluid, and decreases the surface pollution rate of the reverse osmosis membrane, thereby contributing to the improvement of the recovery rate of the reverse osmosis membrane element. The flow passage can be gradually narrowed in the flowing direction of the fluid to ensure that the flow rate is not decreased too much. In addition, measures for enhancing the flowability are taken at the corner, which helps to ensure the use ratio of the reverse osmosis membrane.

Other aspects of the invention will become apparent by consideration of the detailed description and accompanying drawings.

### BRIEF DESCRIPTION OF THE DRAWINGS

FIG. 1 is a perspective view of a spiral wound reverse osmosis membrane assembly according to the prior art;

FIG. 2 is a perspective view of the spiral wound reverse osmosis membrane assembly of FIG. 1, with a reverse osmosis membrane and flow guide net expanded.

FIG. 3 is a schematic diagram of the flow direction of the recovered concentrated water according to the prior art; and

FIG. 4 is a schematic diagram of a manner of applying an adhesive tape according to an embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

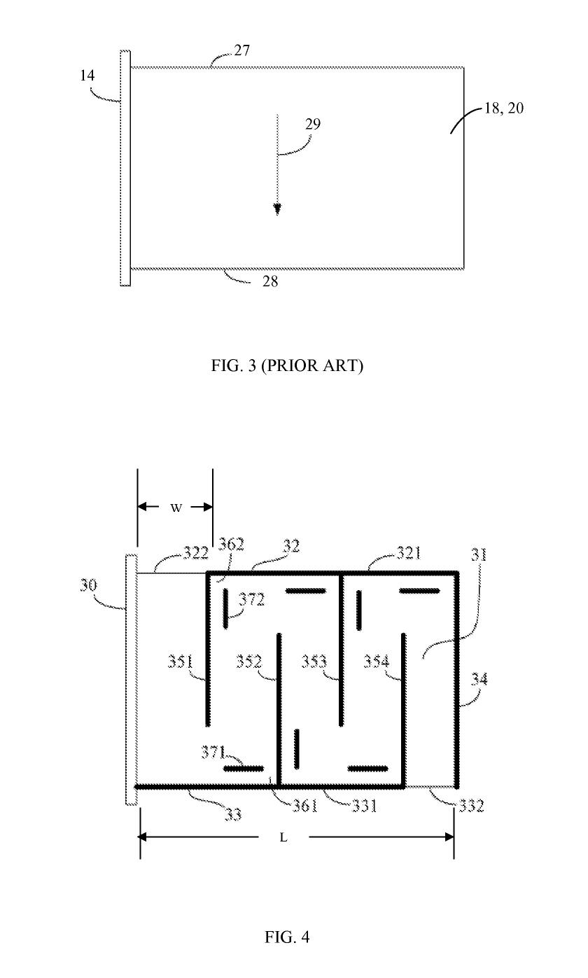

With reference to FIG. 3, the exemplary embodiment of the present invention is described as follows, including various details of the embodiment of the present invention to promote the understanding, and they shall be regarded as just exemplary. Therefore, a person skilled in the art shall appreciate that various changes and modifications can be made to the embodiment described herein, without deviating from the scope and spirit of the present invention. Similarly, in order to be clear and concise, the descriptions of the known functions and structures are omitted in the following content.

In the embodiment of the present invention, waterproof adhesive tapes (hereinafter referred to as ‘adhesive tapes’) are applied between a flow guide net and a reverse osmosis membrane of the reverse osmosis membrane element. The adhesive tapes may be applied on the flow guide net and then bonded with the reverse osmosis membrane, and vice versa. The adhesive tapes can be divided into a plurality of segments including multiple adhesive tapes parallel with an axial direction of the reverse osmosis membrane element. That is, the multiple adhesive tapes are parallel with a central tube, thereby separating the surface of the reverse osmosis membrane into a plurality of flow passages. By adjusting the positions of the adhesive tapes parallel to each other, a circuitous flow passage can be formed. Thus, after the reverse osmosis membrane element is obtained by winding and encapsulating the reverse osmosis membrane and the flow guide net, raw water enters from one end of the reverse osmosis membrane element, and discharged from the other end of the reverse osmosis membrane element after circuitously flowing between adjacent adhesive tapes along the axial direction of the reverse osmosis membrane element. Such flow passages can increase the fluid flow rate, and decrease the surface pollution rate of the reverse osmosis membrane, thereby contributing to the improvement of the recovery rate of the reverse osmosis membrane element. The detailed description is given as follows with reference to the drawing.

FIG. 4 is a schematic diagram of a manner of coating adhesive tapes according to an embodiment of the present invention. Similar to the embodiment described with respect to FIGS. 1-3, an expanded flow guide net 31 is rectangular with one end connected to a central tube 30. As an example, thick and black solid lines on the expanded flow guide net represent adhesive tapes applied thereon. Although not illustrated in FIG. 4, it is to be understood that a reverse osmosis membrane element according to the present invention includes additional features described with respect to the prior-art reverse osmosis membrane element of FIGS. 1-3, including multiple layers of a reverse osmosis membrane alternating with flow guide net layers.

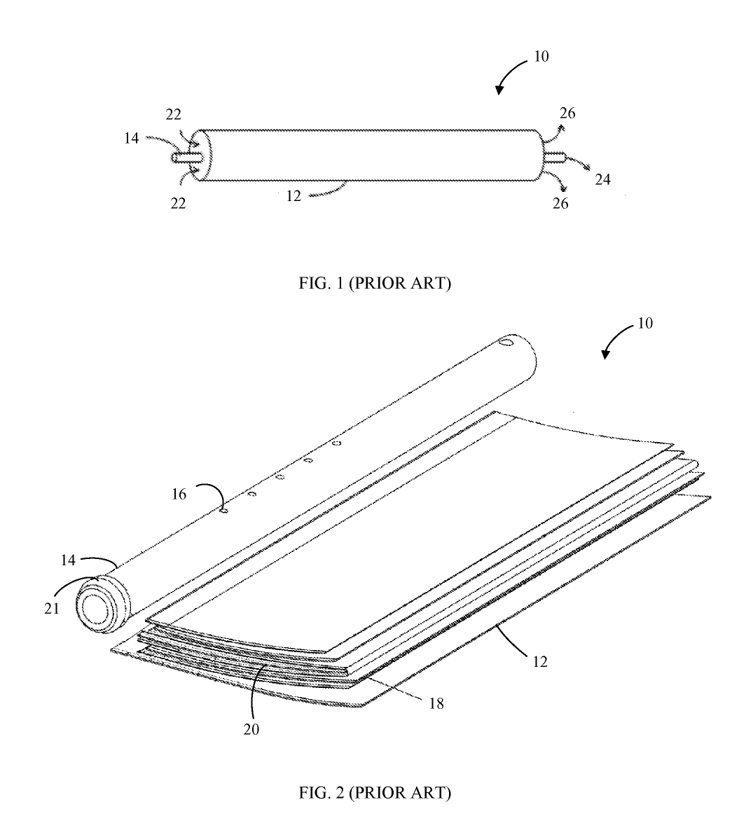

Referring to FIG. 4, edges of a group of opposite sides 32, 33 of the flow guide net 31 parallel with the winding direction of the flow guide net 31 and the reverse osmosis membrane (e.g., the reverse osmosis membrane 18 of FIG. 2) are coated with adhesive tapes 321, 331, respectively. One end of the central tube 30 is a winding start end, and a water port 322 is reserved nearby thereof, i.e., there is no adhesive tape at the water inlet 322. A side 34 opposite to a side where the central tube 30 is located is a winding finish end, and a water port 332 is also reserved at a portion of the side 33 close to the side 34. After winding, either of the water port 322 and the water port 332 is taken as the water inlet, and the other of the water port 322 and 332 is the water outlet. All of the edge of the side 34 serving as the winding finish end is coated with the adhesive tapes.

Flow passages are defined by adhesive tapes 351 to 354, which substantially have the same length and extend alternatively from the side 32 and 33 to the opposite side. The adhesive tapes 351 to 354 are parallel with each other, and are preferably parallel with the central tube 30. If the adhesive tape 351 is on the right side of its position as shown in FIG. 4, the left end of the adhesive tape 321 will influence the water flow. If the adhesive tape 351 is on the left side of its position as shown in FIG. 4, water will be leaked on the right side thereof, which influences the effect of the reverse osmosis membrane on the left side thereof. Therefore, it is preferable that the adhesive tape 351 closest to the central tube 30 intersects the adhesive tape 321 at their end points. Similarly, it is also preferable that the adhesive tape 354 closest to the side 34 crosses the adhesive tape 331 at their end points.

In the state as shown in FIG. 4, a width w of the water port 322, 323 may be 10% to 25% of a length L of the side 32 or the side 33. The width of each flow passage depends on the distance between adjacent adhesive tapes among the adhesive tapes 351 to 354, and it may also be 10% to 25% of the length L of the side 32 or the side 33. If water port 322 is taken as the water inlet and water port 332 is taken as the water outlet, the distance may be gradually narrowed from the adhesive tape 351 to the adhesive tape 354, which is shown in FIG. 4. Due to the reverse osmosis effect, the water in the flow passage is gradually reduced, thus the gradual narrowing of the flow passage helps to ensure that the flow rate is not decreased too much.

After being coated with the adhesive tapes, the flow passage defines corners, such as the corners 361, 362, etc., where fluid seldom flows by, so that the use ratio of the reverse osmosis membrane is influenced. Preferably, a small segment of adhesive tape may be added near the corner, mainly in front of a position where the water flow turns around. For example, when water port 322 is taken as the water inlet, and the flow directions of the water flow at the corners 361, 362 are indicated by arrows nearby, adhesive tape segments 371, 372 may be added respectively. A small segment of adhesive tape may also be added to other corners in the same way, and the added adhesive tape shall be shorter than the adhesive tapes 351 to 354. The addition of a small segment of adhesive tape can improve the fluid flowability in the flow passage nearby thereof, so that the fluid sufficiently flows through the corner, thereby improving the use ratio of the reverse osmosis membrane.

The above embodiment does not constitute a limitation to the scope of the present invention. A person skilled in the art should appreciate that various modifications, combinations, sub-combinations and replacements may occur depending on the design requirement and other factors. Any modification, equivalent replacement and improvement made under the spirit and principle of the present invention shall fall within the scope of the present invention.

Thus, the invention provides, among other things, a reverse osmosis membrane element. Various features and advantages of the invention are set forth in the following claims.

What is claimed is:

1. A reverse osmosis membrane element comprising;
a tube defining an axis;
a flow guide net coupled to the tube at a winding start end and extending to a winding finish end, with opposing first and second sides defined between the winding start end and the winding finish end;
a reverse osmosis membrane coupled to the tube; and
a plurality of axial adhesive tapes applied to the flow guide net between the flow guide net and the reverse osmosis membrane in parallel to the tube so that the water entering the reverse osmosis membrane element is discharged after circuitously flowing between adjacent axial adhesive tapes along an axially-parallel direction of the reverse osmosis membrane element.

2. The reverse osmosis membrane element according to claim 1 and further comprising:
a first side adhesive tape applied to the first side such that a first water port is defined between the tube and the first side adhesive tape; and
a second side adhesive tape applied to the second side such that a second water port is defined between the second side adhesive tape and the winding finish end.

3. The reverse osmosis membrane element according to claim 2, wherein the first water port includes a water inlet port.

4. The reverse osmosis membrane element according to claim 2, wherein the second water port includes a water outlet port.

5. The reverse osmosis membrane element of claim 2, wherein an end portion of the first side adhesive tape member intersects an end portion of one of the plurality of axial adhesive tapes.

6. The reverse osmosis membrane element of claim 2, wherein the plurality of axial adhesive tapes alternately extend from the first and second sides without contacting the opposing first or second side.

7. The reverse osmosis membrane element according to claim 2, wherein a width of the first water port is between approximately 10% and approximately 25% of a length of the flow guide net between the winding start end and the winding finish end.

8. The reverse osmosis membrane element according to claim 7, wherein a distance between two adjacent axial adhesive tapes is between approximately 10% and approximately 25% of the length of the flow guide net between the winding start end and the winding finish end.

9. The reverse osmosis membrane element according to claim 1, wherein a distance between two adjacent axial adhesive tapes decreases from the winding start end to the winding finish end.

10. The reverse osmosis membrane element of claim 1, further comprising:
an adhesive tape segment shorter than the axial adhesive tapes and applied to the flow guide net substantially parallel with a water flow direction and positioned upstream and adjacent to a corner of the water flow.
